(19) United States
(12) Patent Application Publication
(10) Pub. No.: US 2015/0199387 A1
(43) Pub. Date: Jul. 16, 2015

(54) SYSTEMS AND METHODS FOR DETERMINING CAPABILITIES OF A WEB BROWSER

(71) Applicant: Google Inc., Mountain View, CA (US)

(72) Inventor: Jonathan Michael Beri, San Francisco, CA (US)

(73) Assignee: Google Inc., Mountain View, CA (US)

(21) Appl. No.: 13/830,216

(22) Filed: Mar. 14, 2013

(51) Int. Cl. G06F 17/30

(52) U.S. Cl. CPC G06F 17/30283

(57) ABSTRACT

Systems and methods for determining capabilities of a web browser are disclosed. A hash value is received from a web browser, where the has value provides an indication of the one or more capabilities of the web browser. A database, which stores plural hash values and which associates each hash value with a specific set of capabilities of the web browser, is accessed based on the received hash value. A server is requested to provide web content that supports the one or more determined capabilities of the web browser to the web browser.

### BACKGROUND

The subject technology generally relates to determining capabilities of a web browser, and in particular, relates to determining capabilities of a web browser based on a hash value that is transmitted by the web browser.

Different web browsers support different features and have different capabilities. Webpages sometimes contain content and/or features that are not supported by one or more web browsers. However, website developers can aspire to determine capabilities of different web browsers in order to provide each web browser with web content that is supported by the respective web browser.

### SUMMARY

According to one aspect of the subject technology, a computer-implemented method for providing determining capabilities of a web browser is provided. The method comprises receiving, from a web browser, a hash value, wherein the hash value provides an indication of one or more capabilities of the web browser. The method further comprises accessing, based on the received hash value, a database which stores plural hash values and which associates each hash value with a specific set of capabilities of the web browser, to determine the one or more capabilities of the web browser. The method further comprises requesting a server to provide web content that supports the one or more determined capabilities of the web browser to the web browser.

According to another aspect of the subject technology, a system for determining capabilities of a web browser is provided. The system includes one or more processors, and a machine-readable medium including instructions stored therein, which when executed by the processors, cause the processors to perform operations comprising receiving, from a web browser, a hash value, wherein the hash value provides an indication of one or more capabilities of the web browser. The operations further comprise receiving, from the web browser, an identifier that identifies a version of the hash value. The operations further comprise accessing, based on the received hash value and the identifier, a database which stores plural hash values and which associates each hash value with a specific set of capabilities of the web browser, to determine the one or more capabilities of the web browser. The operations further comprise requesting a server to provide web content that supports the one or more determined capabilities of the web browser to the web browser.

According to another aspect of the subject technology, a machine-readable medium including instructions stored therein, which when executed by a system, cause the system to perform operations including receiving, from a web browser, a hash value, wherein the hash value is generated by the web browser at compile time and wherein the hash value provides an indication of one or more capabilities of the web browser is provided. The operations further comprise receiving, from the web browser, an identifier that identifies a version of the hash value. The operations further comprise accessing, based on the received hash value and the identifier, a database which stores plural hash values and which associates each hash value with a specific set of capabilities of the web browser, to determine the one or more capabilities of the web browser. The operations further comprise requesting a server to provide web content that supports the one or more determined capabilities of the web browser to the web browser.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the subject technology as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology. In the drawings:

FIG. 1 illustrates an example network architecture for determining capabilities of a web browser.

FIG. 2 illustrates an example process for determining capabilities of a web browser.

FIG. 3 illustrates an example of a lookup table for capabilities of a web browser.

FIG. 4 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. It will be apparent, however, to those skilled in the art that the subject technology is not limited to the specific details set forth herein and may be practiced without these specific details. In some instances, well-known structures and components are shown in block diagram form in order to avoid obscuring the concepts of the subject technology.

In accordance with the subject disclosure, systems and methods for determining capabilities of a web browser are provided. Examples of web browsers include, but are not limited to, any application for viewing or rending HTML and related web technologies. A web browser is configured to identify its capabilities (e.g., video capabilities, audio capabilities, features supported by the web browser, etc.). The capabilities of the web browser is mapped to a hash value. The web browser generates the hash value during compile time and provides the generated hash value to a server (e.g., a server that is accessible around the world, etc.) that contains a lookup table (look up server) that associates different sets of capabilities of a web browser with different hash values. In one example, a hash value of 111 represents compatibility with HTML audio 5, HTML video 5, and java script whereas a hash value of 101 represents compatibility with HTML audio 5, java script but lack of compatibility with HTML video 5.

Once the application generates the hash value, the application includes the generated hash value in a HTML header and transmits the HTML header together with a request to access web content to the lookup server. In a case where multiple versions of hash value look-ups tables have been released, the web browser may include the version of the look-up table the web browser used together with the hash values in the HTML header and transmit the HTML header to the lookup server.

The lookup server, upon receipt of the hash value, accesses the lookup table to determine, based on the received hash value, the one or more capabilities of the web browser.

If multiple versions of the look-up table are available and the web browser provides the version of the look-up table that was used by the web browser, then the lookup server also accesses the same version of look-up table that was used by the web browser and determines based on the received hash value, the one or more capabilities of the web browser. The lookup server then requests a server that hosts web content (host server) for the webpage that the user is seeking to access to provide web content that is compatible with the one or more determined capabilities of the web browser to the web browser. In some examples, the lookup server and the host server belong to separate servers. In this case, the web content is provided from the host server to the web browser. In other examples, the lookup table and the web content are stored on the same server. In this case, then the lookup server, upon determining the web content that are compatible with the web browser, directly provides the web content to the web browser.

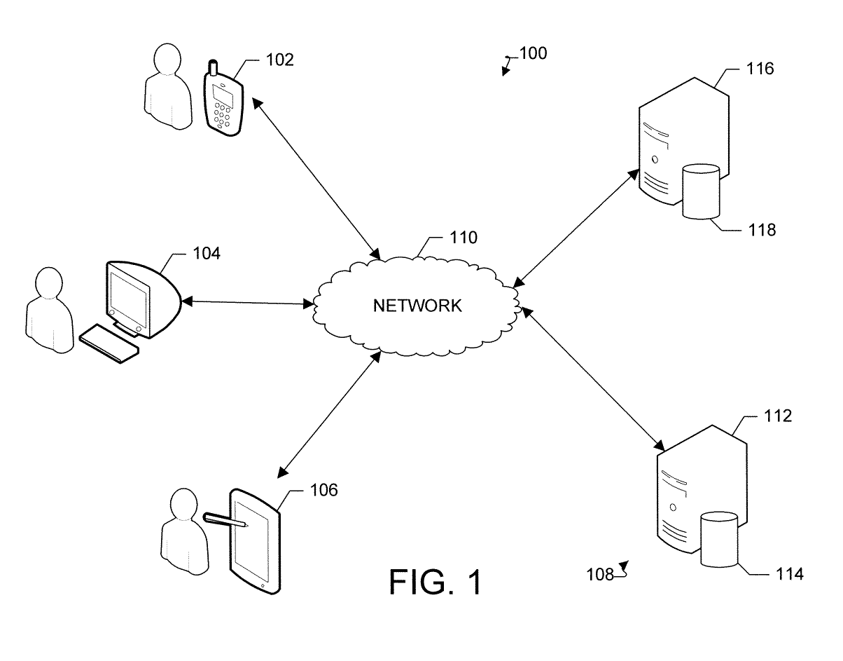

FIG. 1 illustrates an example network architecture for determining capabilities of a web browser. Network architecture 100 includes a number of electronic devices 102, 104, and 106 communicably connected to a lookup server 108 that contains a lookup table of hash values and a host server 116 that hosts web content by a network 110. Lookup server 108 includes a processing device 112 and data store 114. Data store 114 includes storage systems that store the lookup table of hash values. Processing device 112 executes computer instructions stored in a computer-readable medium, for example, to access the lookup table of hash values. Host server 116 hosts web content for different web pages that are stored in data store 118 and is accessible to lookup server 108 via network 110. Example types of web content include, but are not limited to, text-based content, image-based content, audio content, visual content, audiovisual content, multimedia content, etc.

In some example aspects, electronic device 102, 104, or 106 includes any machine that supports a web browser, which provides an interface for accessing web content. Electronic devices 102, 104, and 106 may be mobile devices (e.g., smartphone devices, tablet computers, PDAs, and laptop computers), portable media players, desktop computers, or other computing devices. In the example of FIG. 1, electronic device 102 is depicted as a smartphone device, electronic device 104 is depicted as a desktop computer, and electronic device 106 is depicted as a PDA.

The web browser generates a hash value during compile time and transmits the generated hash value together with a request to access web content to lookup server 108. The hash value provides an indication of the capabilities of the web browser and is transmitted together with a user indication to access web content of a webpage from electronic device 102, 104, or 106 to lookup server 108.

Lookup server 108 may be any system or device having a processor, memory, and communications capability for determining capabilities of a web browser. In one example, lookup server 108 is a globally accessible server and contains a lookup table of different hash values that represent different capabilities of a web browser. In another example, lookup server 108 also contains web content for a webpage that the user is seeking to access. Lookup server 108 may represent more than one computing device working together to perform the actions of a server computer.

Lookup server 108, upon receipt of the generated hash value, accesses data store 114 for the lookup table to determine the capabilities of the web browser. The web browser then requests host server 116 to provide web content that supports the determined capabilities of the web browser to electronic device 102, 104, or 106.

In the example of FIG. 1, lookup server 108 and host server 116 are depicted as separate servers that are communicably connected by network 110. In another example, lookup server 108 and host server 116 are the same server. In this case, both the lookup table and the desired web content are stored in a data store of lookup server 108. Lookup server 108, upon receipt of the hash value from the web browser, accesses the lookup table to determine the capabilities of the web browser and provides web content that is compatible with the web browser to electronic device 102, 104, or 106.

Network 110 may include, for example, any one or more of a cellular network, a satellite network, a personal area network (PAN), a local area network (LAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

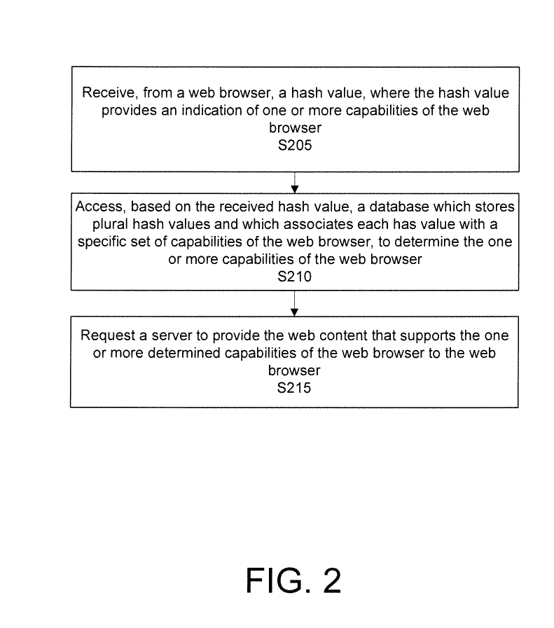

FIG. 2 illustrates an example process 200 for determining capabilities of a web browser. Although the operations in process 200 are shown in a particular order, certain operations may be performed in different orders or at the same time. In addition, although process 200 is described with reference to electronic device 102 and lookup server 108 of FIG. 1, process 200 is not limited to such and can be performed by other electronic devices and/or servers.

A web browser that runs on electronic device 102 provides a user of electronic device 102 an interface for accessing web pages. The web browser may be compatible with certain types of web content that is associated with a web page the user would like to access and incompatible with other types of web content that is associated with the web page. The web browser may be hardcoded with a hash value that provides an indication of the capabilities (e.g., audio capabilities of the web browser, video capabilities of the web browser, multimedia capabilities of the web browser, markup language that the web browser is compatible with, etc.) of the web browser.

The web browser generates the hash value during compile time, and caches the generated hash value for subsequent use. When a user request to access a web page is received, the generated hash value and the request to access the web page are transmitted from the web browser to lookup server 108. The web browser may use multiple versions of hash values. In this case, an identifier that identifies the version of hash values that is used by the web browser may be generated and provided to lookup server 108 together with the generated hash value.

In block S202, lookup server 108 receives the transmitted hash value from electronic device 102. Lookup server 108 then accesses, a database that stores plural hash values to determine the one or more capabilities of the web browser in block S204. In one example the database is stored on a data store of server 108. In another example the database is stored at another location (e.g., on another server, etc.) that is accessible to lookup server 108. If lookup server 108 receives an identifier that identifies the version of the hash value, then lookup server 108 determines the version of hash value received hast value and searches the database for the determined version of the received hash value.

In block S206, lookup server 108 requests a server that hosts web content for a web page that the user is seeking to access to provide web content that supports the one or more determined capabilities of the web browser to the web browser. In the example of FIG. 1, the server that hosts the web content and lookup server 108 are two different servers. In another example, lookup server 108 also hosts web content for the webpage that the user is seeking to access. In this case, lookup server 108 determines capabilities of the web browser and transmits web content that are compatible with the web browser to electronic device 102.

In another example, the data base for the hash values is stored locally on a hardware component of electronic device 102. In this case, electronic device 102 may access the locally stored data base to determine the capabilities of the web browser. Electronic device 102, then transmits a request to access a web page together with the capabilities of the web browser to a server (e.g., server 116) that hosts web content for the webpage.

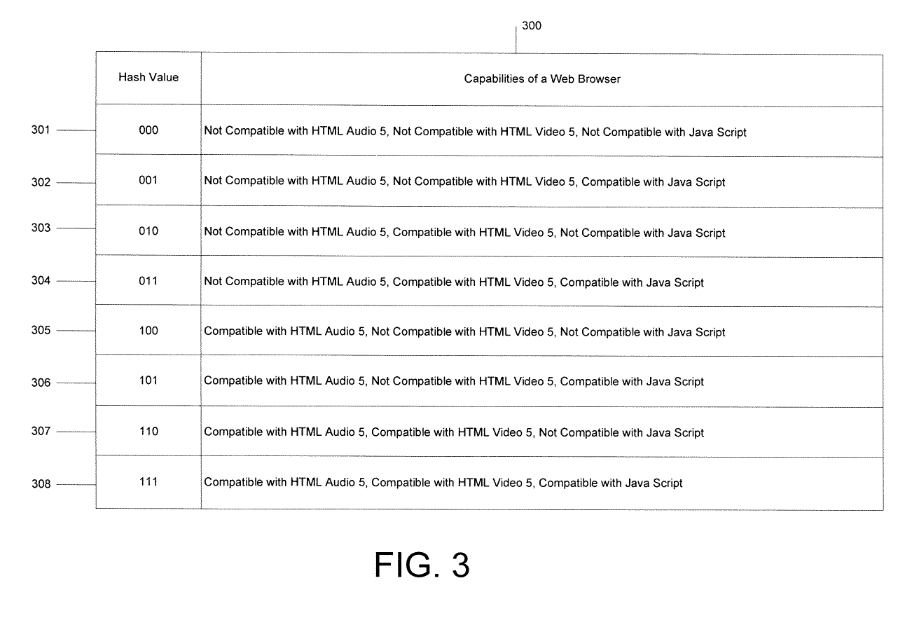

FIG. 3 illustrates an example of a lookup table 300 for capabilities of a web browser. As shown in FIG. 3, lookup table 300 contains 8 hash values, each of which corresponds to a different set of capabilities for the web browser. In other examples, the hash value table may contain a different number of hash values, each of which corresponding to a different set of capabilities of the web browser.

As shown in FIG. 3, a hash value of 000 (301) indicates that the web browser is not compatible with HTML Audio 5, HTML Video 5, or Java Script. As shown in FIG. 3, a hash value of 001 (302) indicates that the web browser is not compatible with HTML Audio 5, not compatible with HTML Video 5, but is compatible with Java Script. As shown in FIG. 3, a hash value of 010 (303) indicates that the web browser is not compatible with HTML Audio 5 or Java Script, but is compatible with HTML Video 5. As shown in FIG. 3, a hash value of 011 (304) indicates that the web browser is not compatible with HTML Audio 5, but is compatible with HTML Video 5 and Java Script. As shown in FIG. 3, a hash value of 100 (305) indicates that the web browser is compatible with HTML Audio 5, but is not compatible with HTML Video 5 or Java Script. As shown in FIG. 3, a hash value of 101 (306) indicates that the web browser is compatible with HTML Audio 5 and Java Script but is not compatible with HTML Video 5. As shown in FIG. 3, a hash value of 110 (307) indicates that the web browser is compatible with HTML Audio 5 and HTML Video 5, but is not compatible with Java Script. As shown in FIG. 3, a hash value of 111 (308) indicates that the web browser is compatible with HTML Audio 5, HTML Video 5, and Java Script.

The web browser may generate one of the listed hash values 301-308 during compile time. In one example, web browser generates a hash value of 111, which indicates that the web browser is compatible with HTML audio 5, HTML video 5, and Java Script. Once hash value 308 has been generated, the generated hash value may be transmitted together with a request to access a web page to a server that contains web content for the web page. The generated hash value may be cached for subsequent use. In that regard, the web browser may transmit the cached hash value together with subsequent requests to access different web pages without having to generate the hash value.

Lookup server 108, upon receipt of the generated hash value, then accesses the lookup table for generated hash value 308. Lookup server 108, then determines, based on generated value 308, that the web browser is compatible with HTML audio 5, HTML video 5, and Java Script. Lookup server 108 then notifies a server that hosts web content for a webpage that the user is seeking to access that the determined compatibility of the user's web browser and requests the server that hosts the web content to provide web content that is compatible with the user's web browser to the web browser.

In some examples, lookup server 108 also hosts web content for a webpage that the user is seeking to access. In this case, lookup server 108, upon determining capabilities of the web browser, obtains web content that is compatible with the determined capabilities of the web browser, and transmits the obtained web content for display on an interface of the web browser.

In some examples, the look up table is stored on an electronic device that the web browser is also running on. In this case, then the hash table is accessed locally and a processor of the web browser determines the capabilities of the web browser by looking up the hash table for the generated hash values. The web browser then transmits a request to the server that hosts the web content to provide web content that the web browser is compatible with to the web browser.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

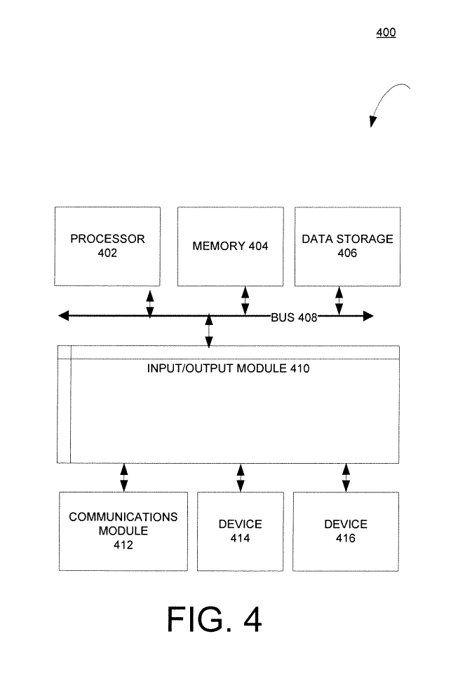

FIG. 4 conceptually illustrates an electronic system with which some implementations of the subject technology are implemented. In certain aspects, the computer system 400 may be implemented using hardware or a combination of software and hardware, either in a dedicated server, or integrated into another entity, or distributed across multiple entities.

Computer system 400 (e.g., electronic device 102, 104, or 106 and lookup server 108) includes a bus 408 or other communication mechanism for communicating information, and a processor 402 coupled with bus 408 for processing information. By way of example, the computer system 400 may be implemented with one or more processors 402. Processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, e.g., code that constitutes processor firmware, a protocol stack, a database management system, an operating system, or a combination of one or more of them stored in an included memory 404, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The processor 402 and the memory 404 can be supplemented by, or incorporated in, special purpose logic circuitry.

The instructions may be stored in the memory 404 and implemented in one or more computer program products, i.e., one or more modules of computer program instructions encoded on a computer readable medium for execution by, or to control the operation of, the computer system 400, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 404 may also be used for storing temporary variable or other intermediate information during execution of instructions to be executed by processor 402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 400 further includes a data storage device 406 such as a magnetic disk or optical disk, coupled to bus 408 for storing information and instructions. Computer system 400 may be coupled via input/output module 410 to various devices. The input/output module 410 can be any input/output module. Exemplary input/output modules 410 include data ports such as USB ports. The input/output module 410 is configured to connect to a communications module 412. Exemplary communications modules 412 include networking interface cards, such as Ethernet cards and modems. In certain aspects, the input/output module 410 is configured to connect to a plurality of devices, such as an input device 414 and/or an output device 416. Exemplary input devices 414 include a keyboard and a pointing device, e.g., a mouse or a trackball, by which a user can provide input to the computer system 400. Other kinds of input devices 414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 416 include display devices, such as a CRT (cathode ray tube) or LCD (liquid crystal display) monitor, for displaying information to the user.

According to one aspect of the present disclosure, the electronic device 102, 104, or 106 and lookup server 108 can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in main memory 404 causes processor 402 to perform the process steps described herein. One or more processors in a multi-processing arrangement may also be employed to execute the sequences of instructions contained in memory 404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a computer device having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 110) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 400 can include electronic devices 102, 104, or 106 and servers 108. An electronic device 102, 104, or 106 and lookup server 108 are generally remote from each other and typically interact through a communication network. The relationship of the electronic device 102, 104, or 106 and lookup server 108 arises by virtue of computer programs running on the respective computers and having an electronic device-server relationship to each other. Computer system 400 can be, for example, and without limitation, a touchscreen device, a desktop computer, laptop computer, or tablet computer. Computer system 400 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions to processor 402 for execution. Such a medium may take many forms, including, but not limited to, non-volatile media, volatile media, and transmission media. Non-volatile media include, for example, optical or magnetic disks, such as data storage device 406. Volatile media include dynamic memory, such as memory 404. Transmission media include coaxial cables, copper wire, and fiber optics, including the wires that comprise bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A computer-implemented method for determining capabilities of a web browser, the method comprising:
receiving, from a web browser, a hash value, wherein the hash value provides an indication of one or more capabilities of the web browser;
accessing, based on the received hash value, a database which stores plural hash values and which associates each hash value with a specific set of capabilities of the web browser, to determine the one or more capabilities of the web browser; and
requesting a server to provide web content that supports the one or more determined capabilities of the web browser to the web browser.

2. The computer-implemented method of claim 1, wherein the hash value is generated at compile time by a compiler of the web browser.

3. The computer-implemented method of claim 2, wherein the generated hash value is cached by the web browser.

4. The computer-implemented method of claim 1, further comprising:
receiving, from the web browser, an identifier that identifies a version of the hash value; wherein
the accessing comprises accessing, based on the received hash value and the received identifier, the database to determine the one or more capabilities of the web browser.

5. The computer-implemented method of claim 1, wherein the one or more capabilities identify audio capabilities of the web browser.

6. The computer-implemented method of claim 1, wherein the one or more capabilities identify video capabilities of the web browser.

7. The computer-implemented method of claim 1, wherein the one or more capabilities identify a markup language that is compatible with the web browser.

8. The computer-implemented method of claim 1, wherein the hash value is received by a lookup server that contains the database of the plural of hash values, and wherein the accessing and the requesting are performed by a processor of the lookup server.

9. The computer-implemented method of claim 1, wherein the hash value is received by the server that provides the web content, the method further comprising providing the web content for display to the web browser.

10. The computer-implemented method of claim 1, wherein the web browser is running on an electronic device that hosts the database, and
wherein the accessing and the requesting are performed by the electronic device.

11. A system for determining capabilities of a web browser, the system comprising:
one or more processors; and
a machine-readable medium comprising instructions stored therein, which when executed by the processors, cause the processors to perform operations comprising:
receiving, from a web browser, a hash value, wherein the hash value provides an indication of one or more capabilities of the web browser;
receiving, from the web browser, an identifier that identifies a version of the hash value;
accessing, based on the received hash value and the identifier, a database which stores plural hash values and which associates each hash value with a specific set of capabilities of the web browser, to determine the one or more capabilities of the web browser; and
requesting a server to provide web content that supports the one or more determined capabilities of the web browser to the web browser.

12. The system of claim 11, wherein the hash value is generated at compile time by a compiler of the web browser.

13. The system of claim 12, wherein the generated hash value is cached by the web browser.

14. The system of claim 11, wherein the one or more capabilities identify audio capabilities of the web browser.

15. The system of claim 11, wherein the one or more capabilities identify video capabilities of the web browser.

16. The system of claim 11, wherein the one or more capabilities identify a markup language that is compatible with the web browser.

17. The system of claim 11, wherein the database is stored on a lookup server, and wherein the accessing and the requesting are performed by a processor of the lookup server.

18. The system of claim 11, wherein the hash value is received by a lookup server that contains the database of the plural of hash values, and wherein the accessing and the requesting are performed by a processor of the lookup server.

19. The system of claim 11, wherein the web browser is running on an electronic device that hosts the database, and
wherein the accessing and the requesting are performed by the electronic device.

20. A machine-readable medium comprising instructions stored therein, which when executed by a system, cause the system to perform operations comprising:
receiving, from a web browser, a hash value, wherein the hash value is generated by the web browser at compile time and wherein the hash value provides an indication of one or more capabilities of the web browser;
receiving, from the web browser, an identifier that identifies a version of the hash value;
accessing, based on the received hash value and the identifier, a database which stores plural hash values and which associates each hash value with a specific set of capabilities of the web browser, to determine the one or more capabilities of the web browser; and
requesting a server to provide web content that supports the one or more determined capabilities of the web browser to the web browser.
